(19) United States
(12) Patent Application Publication
(10) Pub. No.: US 2022/0194387 A1
(43) Pub. Date: Jun. 23, 2022

(54) LEANING-AGAINST-VEHICLE DOOR DETECTION SYSTEM

(71) Applicant: TOYOTA JIDOSHA KABUSHIKI KAISHA, Toyota-shi Aichi-ken (JP)

(72) Inventor: Kentaro Oya, Toyota-shi Aichi-ken (JP)

(73) Assignee: TOYOTA JIDOSHA KABUSHIKI KAISHA, Toyota-shi Aichi-ken (JP)

(21) Appl. No.: 17/493,094

(22) Filed: Oct. 4, 2021

(30) Foreign Application Priority Data
Dec. 18, 2020 (JP) 2020-209978

(51) Int. Cl. B60W 40/08; G06K 9/00

(52) U.S. Cl. CPC B60W 40/08; G06K 9/00832; G06K 9/00228; B60W 2420/42; B60W 2540/01; B60W 2540/223; B60W 2540/227; G06K 9/00201

(57) ABSTRACT

A leaning-against-vehicle door detection system includes an imager and a determination device. The imager has an image pickup range including a door of a vehicle and the vicinity of the door inside a vehicle cabin. The determination device determines whether or not there is a passenger or luggage leaning against the door, from an image picked up by the imager.

### CROSS-REFERENCE TO RELATED APPLICATION

This application claims priority to Japanese Patent Application No. 2020-209978 filed on Dec. 18, 2020, incorporated herein by reference in its entirety.

### BACKGROUND

### 1. Technical Field

The present description discloses a detection system that detects whether or not there is a passenger or luggage leaning against a vehicle door.

### 2. Description of Related Art

For smooth operation of vehicles, the vehicles are each equipped with various sensors and devices. For example, in Japanese Unexamined Patent Application Publication No. 2018-162042, a shared vehicle such as a bus is equipped with a camera that picks up an image of an area outside the vehicle. Based on the image picked up by the camera, whether or not there are a space for parking the vehicle and a space for setting a slope is determined.

### SUMMARY

In a case where a passenger or luggage is leaning against a door of a vehicle, the passenger or the luggage may fall out of the vehicle when the door is opened. Therefore, the present description discloses a leaning-against-vehicle door detection system that enables ensuring safety of a passenger or luggage when a door is opened.

The leaning-against-vehicle door detection system disclosed in the present description includes an imager and a determination device. The imager has an image pickup range including a door of a vehicle and the vicinity of the door inside a vehicle cabin. The determination device determines whether or not there is a passenger or luggage leaning against the door, from an image picked up by the imager.

According to the above configuration, the determination device determines whether or not there is a passenger or luggage leaning against the door, based on a picked-up image of the vicinity of the door, enabling ensuring safety of a passenger or luggage when the door is opened.

Also, in the above configuration, the determination device may include a face recognition section, a head pose estimation section and a passenger leaning determination section. The face recognition section recognizes the face of a passenger in the vicinity of the door from the picked-up image. The head pose estimation section estimates a direction of the recognized face. The passenger leaning determination section determines whether or not the passenger is leaning against the door, based on the estimated direction of the face.

When there is a passenger in the vicinity of the door, estimating the direction of the face of the passenger relative to the door enables accurate determination of whether or not the passenger is leaning against the door.

Also, in the above configuration, the determination device may include a luggage recognition section and a luggage leaning determination section. In this case, the luggage recognition section recognizes luggage in the vicinity of the door, from the picked-up image. The luggage leaning determination section determines whether or not the recognized luggage is leaning against the door, based on the distance between the luggage and the door.

According to the above configuration, it is possible to determine whether or not a luggage is leaning against the door, based on the distance between the luggage and the door.

Also, in the above configuration, the leaning-against-vehicle door detection system may include an alarm. When it is determined by the determination device that there is a passenger or luggage leaning against the door, the alarm issues an alarm before opening of the door.

According to the above configuration, it is possible to urge movement of a passenger or luggage leaning against the door away from the door before opening of the door.

Also, in the above configuration, the leaning-against-vehicle door detection system may include a door control section. When it is determined by the determination device that there is a passenger or luggage leaning against the door, the door control section makes the door open at a cautionary speed that is slower than a predetermined normal opening speed.

According to the above configuration, as a result of the door being opened at the cautionary speed, a passenger leaning against the door or a passenger who has placed his/her luggage in such a manner that the luggage is leaning against the door notices the opening of the door, which leads to discontinuation of the leaning.

Also, in the above configuration, when it is determined by the determination device that the passenger or the luggage leaning against the door is discontinued, the door control section may make the door open at the normal opening speed.

According to the above configuration, upon a passenger or luggage leaning against the door being discontinued, the door is promptly opened, enabling curbing of an effect on an operation schedule of the vehicle.

The leaning-against-vehicle door detection system disclosed in the present description enables ensuring safety of a passenger or luggage when a door is opened.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view illustrating an example vehicle including a leaning-against-vehicle door detection system according to the present embodiment;

FIG. 2 is a perspective view illustrating an example appearance of the vehicle when doors are opened;

FIG. 3 is a diagram illustrating an example of the inside of a vehicle cabin;

FIG. 4 is a diagram illustrating an example hardware configuration of the leaning-against-vehicle door detection system according to the present embodiment;

FIG. 5 is a diagram illustrating example functional blocks of the leaning-against-vehicle door detection system according to the present embodiment;

FIG. 6 is a diagram illustrating an example of a passenger leaning against a door;

FIG. 7 is a diagram illustrates an example of a case where a passenger in the vicinity of a door is not leaning against the door;

FIG. 8 is a diagram illustrating an example of a passenger leaning determination flow in the leaning-against-vehicle door detection system according to the present embodiment;

FIG. 9 is a diagram illustrating another example of a passenger leaning determination flow in the leaning-against-vehicle door detection system according to the present embodiment;

FIG. 10 is a diagram illustrating an example of luggage leaning against a door;

FIG. 11 is a diagram illustrating an example of a luggage leaning determination flow in the leaning-against-vehicle door detection system according to the present embodiment;

and

FIG. 12 is a diagram illustrating another example of a luggage leaning determination flow in the leaning-against-vehicle door detection system according to the present embodiment.

### DETAILED DESCRIPTION OF EMBODIMENTS

Vehicle Configuration

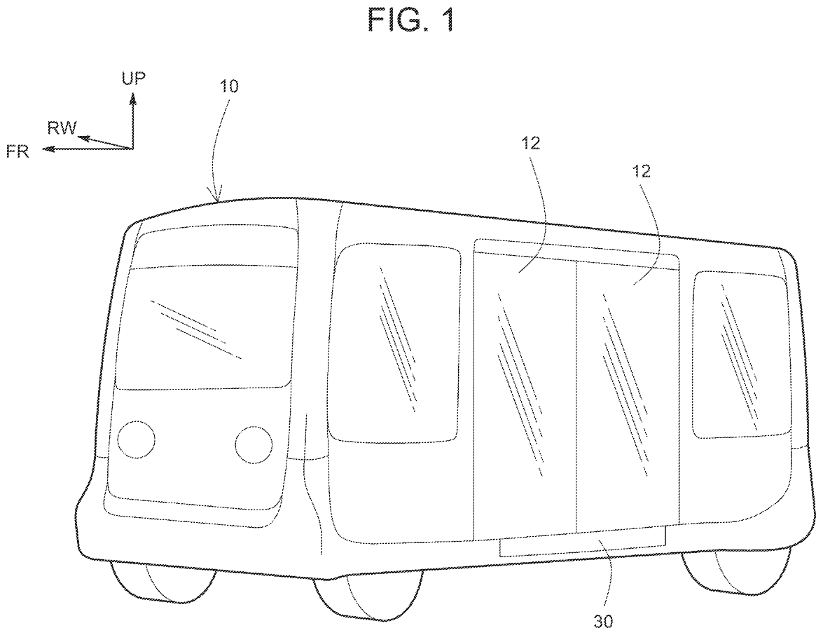

FIG. 1 discloses a vehicle 10 including a leaning-against-vehicle door detection system according to the present embodiment. In FIGS. 1, 2, 3, 6, 7 and 10, a vehicle front-rear direction is indicated by the axis denoted by sign FR, a vehicle width direction is indicated by the axis denoted by sign RW, and a vertical direction is indicated by the axis denoted by sign UP. A positive direction on the front-rear direction axis FR is the vehicle front side. A positive direction on the width direction axis RW is a rightward direction. Also, a positive direction of the height axis UP is an upward direction. These three axes are orthogonal to one another.

The vehicle 10 illustrated in FIG. 1 as an example has a size that, for example, is nearly the same as that of a minibus and is used as a shared vehicle. For example, the vehicle 10 travels on a prescribed route and stops at each of stops provided along the route.

The vehicle 10 may be an electric vehicle using a non-illustrated rotating electrical machine as a drive source. Alternatively, the vehicle 10 may uses an internal combustion engine as a drive source. Also, the vehicle 10 is switchable between manual driving and autonomous driving.

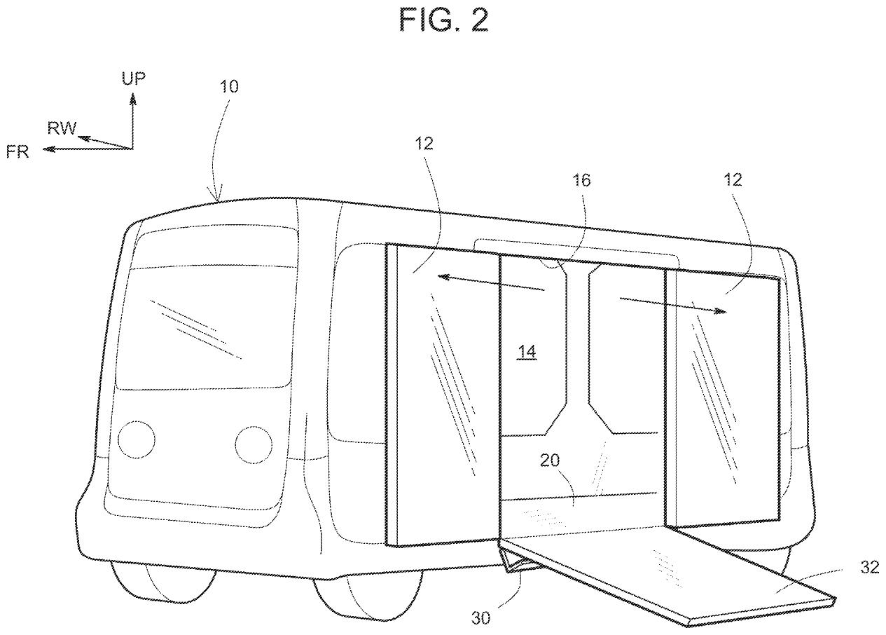

Double doors 12, 12 are provided at a side surface, that is, a surface perpendicular to the RW axis (UP-FR plane) of the vehicle 10. The doors 12, 12 are, for example, suspended outward sliding doors, and a non-illustrated rail mechanism is provided above the doors 12, 12. As a result of the doors 12, 12 being of a suspended type, interference with a slope plate 32 (see FIG. 2) provided below the doors 12, 12 can be avoided.

As illustrated by example in FIG. 2, when the doors 12, 12 are opened, the doors 12, 12 are jutted outward in the vehicle width direction and further moved in the vehicle front-rear direction. As a result of the doors 12, 12 being moved from a closed position to an open position in this way, an entrance 16 is opened.

As described above, since the doors 12, 12 of the vehicle 10 are outward sliding doors that are moved to the vehicle outer side when the doors 12, 12 are opened, for example, unlike folding doors that are opened by being folded to the vehicle cabin 14 side, there is no need to set the vicinity of the doors as a keep-out area. In other words, in the vehicle 10, even the space in the vicinity of the doors 12, 12 of a vehicle cabin 14 can be used as passenger standing space, and thus, passengers highly frequently lean against the doors 12, 12 in comparison with a case where the space is set as a keep-out space.

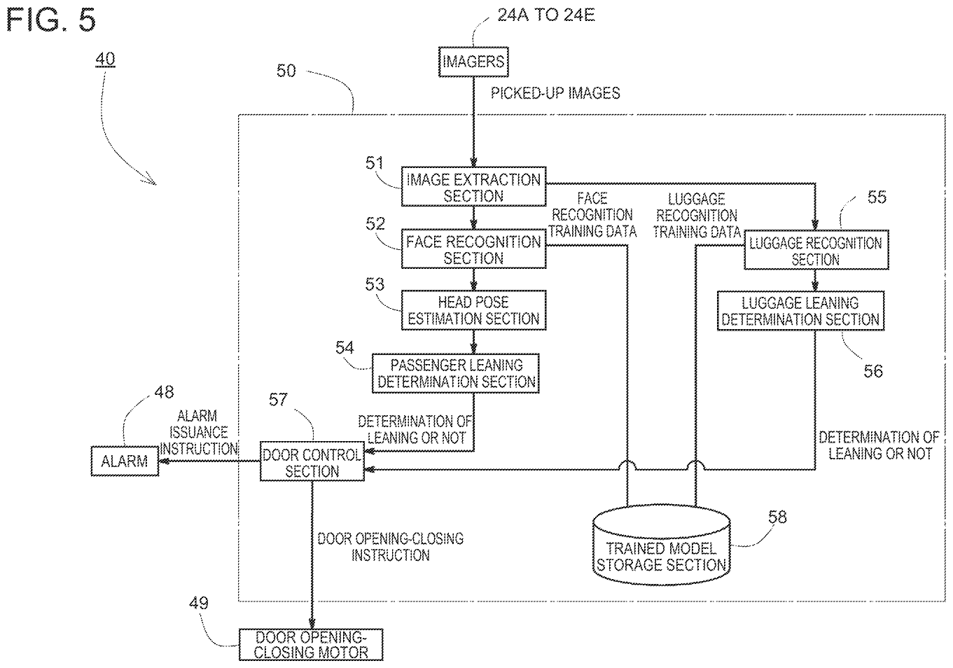

As described later, the leaning-against-vehicle door detection system 40 (see FIG. 5) according to the present embodiment detects a passenger and/or luggage leaning against a door 12, 12 to discontinue the leaning when the doors 12, 12 are opened/closed. Here, in order to curb the leaning, the area in the vicinity of the doors 12, 12 of the vehicle cabin 14 may be set as a keep-out area and, for example, a color of a vehicle cabin floor 20 in the area may be different from that of an area around the area.

In operation in boarding and alighting, for example, upon the vehicle 10 arriving and stopping at a stop, first, a slope cover 30 is opened and the slope plate 32 is pulled out. The opening of the slope cover 30 and the pull-out of the slope plate 32 are, for example, automatically performed by a slope device including, e.g., a non-illustrated motor. Upon completion of the pull-out of the slope plate 32, the doors 12, 12 are opened, enabling passenger boarding and alighting. After an end of the passenger boarding and alighting, the doors 12, 12 are closed. Subsequently, the slope plate 32 is retracted to the inner side in the vehicle width direction by the slope device and the slope cover 30 is closed.

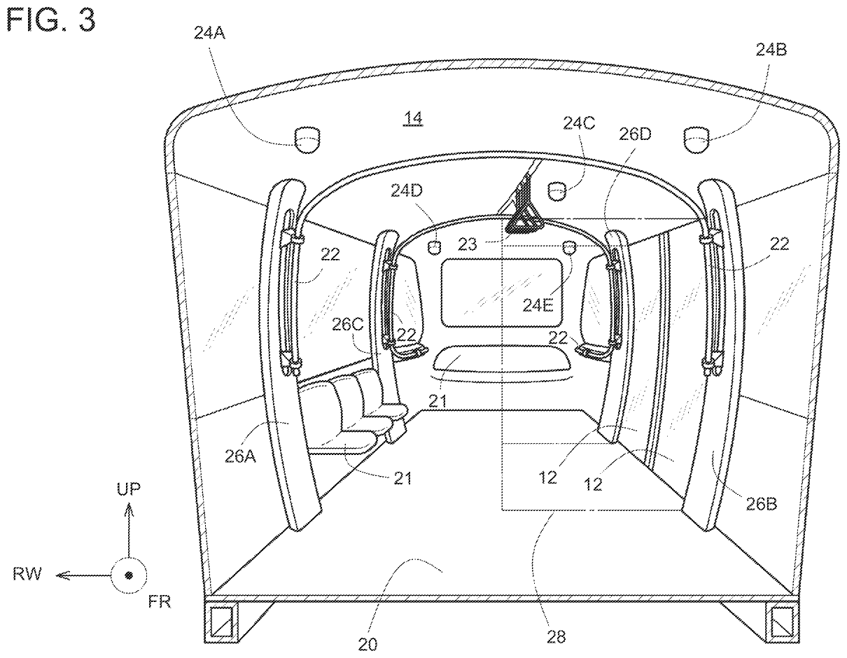

FIG. 3 illustrates an example layout inside the vehicle cabin 14. The vehicle cabin 14 is roughly divided into a driver seat area (not illustrated) and a passenger area. FIG. 3 illustrates the passenger area. In the passenger area, a plurality of seats 21 are provided. The seats 21 are provided at a position away from the doors 12, 12. For example, the seats 21 are provided on a side surface opposite to the side surface at which the doors 12, 12 are provided and a rear end of the vehicle cabin 14.

An area, in which no seats 21 are provided, of the passenger area is a standing passenger area. In the standing passenger area, handrails 22 are provided on side walls of the vehicle cabin 14 and hanging straps 23 are provided on a ceiling wall of the vehicle cabin 14. For example, the handrails 22 are provided on side posts 26B, 26D provided on opposite sides of the doors 12, 12 and side posts 26A, 26C facing the respective side posts 26B, 26D in the vehicle width direction. The side posts 26A to 26D extend from the vehicle cabin floor 20 to the ceiling in the height direction.

Furthermore, a plurality of imagers 24 are provided in the vehicle cabin 14. In the example in FIG. 3, five imagers 24A to 24E are provided on the ceiling surface of the vehicle cabin 14. Instead of the above, an imager 24C may be provided on a center portion in the vehicle width direction and the vehicle front-rear direction of the ceiling surface and imagers 24A, 24B, 24D, 24E may be provided on parts, near the respective side posts 26A to 26D, of the ceiling surface.

Each of the imagers 24A to 24E includes an image pickup device, for example, a CMOS sensor or a CCD sensor, and is capable of picking up at least either a still image or a moving image of the inside of the vehicle cabin 14. For example, each of the imagers 24A to 24E may be a 360-degree dome camera (omnidirectional camera).

The imagers 24A to 24E have respective image pickup ranges each including the doors 12, 12 of the vehicle 10 and the vicinity of the doors 12, 12 in the vehicle cabin 14. In other words, the image pickup ranges of the imagers 24A to 24E overlap in the doors 12, 12 and the vicinity of the doors 12, 12. As described later, the overlap of areas for image pickup of the doors 12, 12 and areas in the vicinity of the doors 12, 12 by the plurality of imagers 24A to 24E enables three-dimensional positions of a passenger and/or luggage in the vicinity of the doors 12, 12 to be obtained based on what is called the principle of stereo camera.

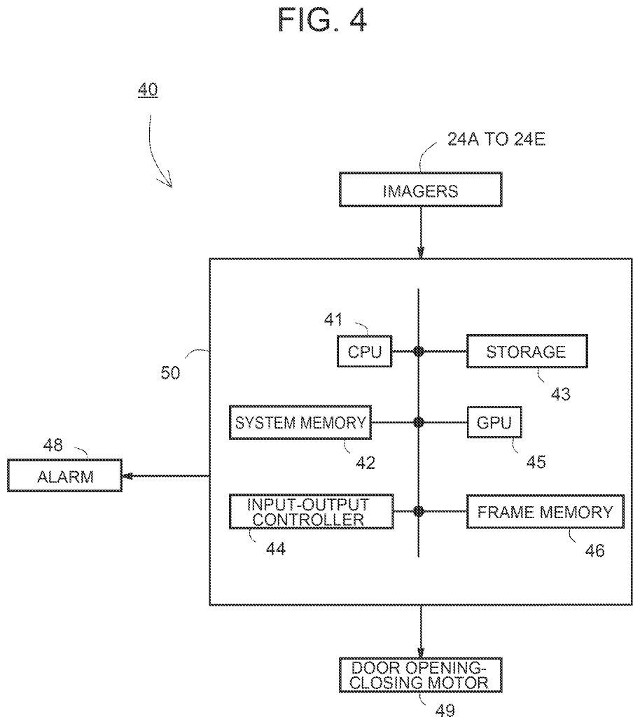

FIG. 4 illustrates an example hardware configuration of the leaning-against-vehicle door detection system 40 according to the present embodiment. The system 40 includes the imagers 24A to 24E, a determination device 50, an alarm 48 and a door opening-closing motor 49.

Configuration of Determination Device

The determination device 50 determines whether or not there is a passenger or luggage leaning against a door, from images picked up by the imagers 24A to 24E. The determination device 50 is formed of, for example, a computer. The determination device 50 includes a CPU 41, which is an arithmetic device, and a system memory 42 and a storage device 43, which serve as storage unit. The storage device 43 may be, for example, a non-transitory storage device such as a hard disk drive (HDD) or a solid-state drive (SSD). Also, the determination device 50 includes an input-output controller 44 that controls input/output of information to/from external devices such as the imagers 24A to 24E, the alarm 48 and the door opening-closing motor 49.

The determination device 50 further includes a graphics processing unit (GPU) 45 and a frame memory 46 for processing images picked up by the imagers 24A to 24E. The determination device 50 may further include a display section that displays an image resulting from processing by the GPU 45.

The GPU 45 is an arithmetic device for image processing and operates mainly when later-described passenger leaning determination or luggage leaning determination is performed. The frame memory 46 is a storage device that stores an image obtained by images picked up by the imagers 24A to 24E being subjected to arithmetic processing in the GPU 45.

FIG. 5 illustrates the leaning-against-vehicle door detection system 40 in which functional blocks of the determination device 50 are illustrated. The functional blocks are configured, for example, by execution of a program by the CPU 41, the program being stored in the storage device 43 of the determination device 50 or a computer-readable non-transitory storage medium such as a DVD.

The determination device 50 includes an image extraction section 51, a face recognition section 52, a head pose estimation section 53, a passenger leaning determination section 54, a luggage recognition section 55, a luggage leaning determination section 56 and a door control section 57 as processing function sections. The determination device 50 further includes a trained model storage section 58 that stores training data for the face recognition section 52 and the luggage recognition section 55.

The image extraction section 51 extracts (clips) an image of the doors 12, 12 and the vicinity of the doors 12, 12 in the vehicle cabin 14 from images of the inside of the vehicle cabin 14, the images being picked up by the imagers 24A to 24E. The vicinity of the doors 12, 12 may be, for example, a door vicinity area 28, which is illustrated in FIG. 3. The door vicinity area 28 includes, for example, a space area having a dimension in the vehicle width direction from the doors 12, 12 to a center in the vehicle width direction of the vehicle cabin 14, a dimension in the vehicle front-rear direction from the side post 26B to the side post 26D and a dimension in the vehicle height direction from the vehicle cabin floor 20 to the ceiling surface.

For example, the image pickup ranges of the imagers 24A to 24E are known according to magnifications thereof. Therefore, the image extraction section 51 extracts the door vicinity area 28 included in each of the images picked up by the imagers 24A to 24E, according to the relevant magnification at the time of the image being picked up.

The face recognition section 52 recognizes, from each of the images of the door vicinity area 28 (door vicinity images) extracted by the image extraction section 51, whether or not the image includes a face image area of a passenger. The face recognition section 52 includes, for example, a convolutional neural network (CNN).

The convolutional neural network of the face recognition section 52 is trained in advance by training data with face images as input data and a passenger's face, which is a class name indicating a recognized object, as output data (ground truth data). The training data is stored in the trained model storage section 58. The face recognition section 52 recognizes, from each of all images of the door vicinity area 28 from the imagers 24A to 24E, whether or not the image includes a face image area of a passenger.

Note that three-dimensional coordinates, in the vehicle cabin 14, of a passenger whose face has been recognized by the face recognition section 52 may be obtained. The three-dimensional coordinates can be obtained by, for example, a stereo camera system using two of the imagers 24A to 24E. Since stereo camera is a known technique, description thereof will be omitted here. For example, the face recognition section 52 selects an arbitrary combination of two of the imagers 24A to 24E and obtains three-dimensional coordinates of the face image area from the respective images picked up by the two pickup devices.

Also, the face recognition section 52 may select an arbitrary combination of two of the imagers 24A to 24E and then obtains a three-dimensional image of a recognized face image area from at least one of images picked up by the two imagers. For example, there may be an angle at which face recognition is difficult, such as only the back side of the head of a passenger is shown, with one of the two imagers. Even in such case, it is possible to obtain three-dimensional coordinates of a face image area of the passenger based on the face of the passenger shown in the image picked up by the other imager.

Furthermore, the face recognition section 52 may perform range filtering in such a manner as to, e.g., transmit only a face image area whose three-dimensional coordinates are close to the doors 12, 12, to the head pose estimation section 53. For example, only a face image area, a distance of a representative point (for example, the tip of the nose) of the face image area and a representative point of the doors 12, 12 (for example, a center point in the vehicle front-rear direction and the vehicle height direction of one of the doors 12, 12) being within a predetermined distance (for example, 50 cm), is extracted. Furthermore, data of the door vicinity image including the extracted face image area is transmitted to the head pose estimation section 53. Such range filtering above enables reduction in arithmetic operation load on the determination device 50.

The head pose estimation section 53 estimates a direction of the face of the passenger based on the face image area recognized by the face recognition section 52. Head pose estimation is a known technique and thus will be only briefly described here: the head pose estimation section 53 detects feature points (e.g., ends of the eyes, the nose and the mouth) in the face image area and estimates a head pose, that is, a direction and an angle of the face from a positional relationship between the feature points.

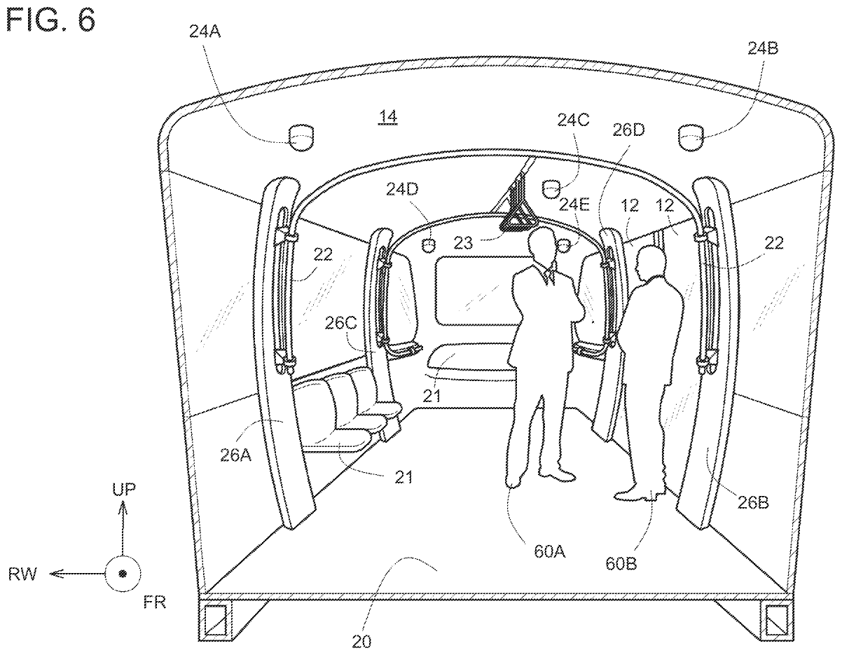

The passenger leaning determination section 54 determines whether or not the passenger is leaning against a door 12, 12, based on the direction of the face (head pose) of the passenger, which has been estimated by the head pose estimation section 53. For example, FIG. 6 illustrates an example in which there are standing passengers 60A, 60B in the vehicle cabin 14. Of the passengers 60A, 60B, the passenger 60B closer to the doors 12, 12 stands with his back to the doors 12, 12 and is highly likely to be leaning against the door 12, 12.

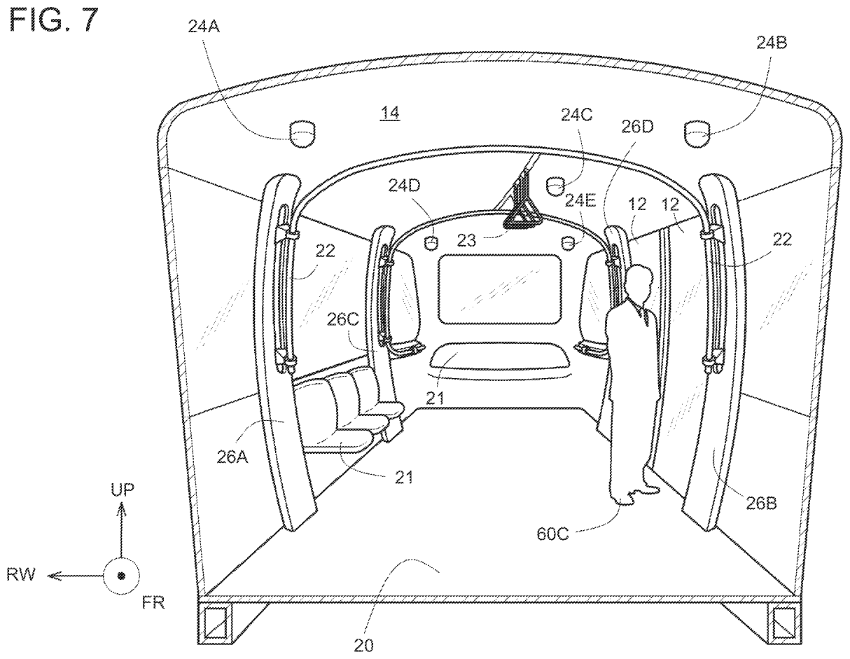

On the other hand, FIG. 7 illustrates an example in which there is a standing passenger 60C in the vehicle cabin 14. In this example, the passenger 60C stands in the vicinity of the doors 12, 12, but his line of sight is directed toward the doors 12, 12 and the passenger 60C faces the doors 12, 12. In other words, the passenger 60C is estimated to be not leaning against the door 12, 12.

The passenger leaning determination section 54 determines whether or not a passenger is leaning against the door 12, 12 based on the direction of the face of the passenger relative to the doors 12, 12. For example, the passenger leaning determination section 54 calculates an angle θ of the passenger's line of sight (hereinafter, “line-of-sight angle θ” as appropriate) relative to a surface on the vehicle cabin side of the doors 12, 12. For example, in a case where the line-of-sight angle θ=90°, the passenger faces the doors 12, 12. Also, for example, in a case where the line-of-sight angle θ=0° or 180°, the passenger's light of sight is directed to the vehicle front side or the vehicle rear side.

Based on the face area image data transmitted from the head pose estimation section 53, the passenger leaning determination section 54 determines that the passenger having the light of sight is not leaning against the door 12, 12 if the line-of-sight angle θ falls within a range of, for example, no less than 45° but no more than 135°. On the other hand, if the line-of-sight angle θ of a passenger is no less than 0° but less than 45° or no less than 135° but less than 360°, the passenger leaning determination section 54 determines that the passenger is leaning against the door 12, 12. The result of the determination of the passenger leaning or not is transmitted to the door control section 57.

The door control section 57 controls driving of the door opening-closing motor 49 that opens/closes the doors 12, 12. The door control section 57 receives the result of the determination of the passenger leaning or not from the passenger leaning determination section 54 and also receives a result of determination of luggage leaning or not from the later-described luggage leaning determination section 56. Upon reception of a determination result that there is no passenger leaning from the passenger leaning determination section 54 and upon reception of a determination result that there is no luggage leaning from the luggage leaning determination section 56, the door control section 57 controls the door opening-closing motor 49 to open the doors 12, 12 at a predetermined normal opening speed.

On the other hand, upon reception of a determination result that there is a passenger leaning from the passenger leaning determination section 54 or upon reception of a determination result that there is luggage leaning from the luggage leaning determination section 56, the door control section 57 controls the door opening-closing motor 49 to open the doors 12, 12 at a cautionary speed that is slower that the normal opening speed. For example, the cautionary speed is set to be half the normal opening speed.

As described later, in order to discontinue leaning against the door 12, 12, an alarm is output from the alarm 48. On the other hand, for example, in a case where a passenger leaning against the door 12, 12 (leaning passenger) is listening to music on earphones while viewing a display of a mobile terminal, the passenger may fail to notice the alarm from the alarm 48.

Even in such case, as a result of the doors 12, 12 moving, the passenger who is leaning against the door 12, 12 is likely to notice the movement and move away from the doors 12, 12. Therefore, the door control section 57 makes the doors 12, 12 open at a speed that makes the leaning passenger notice the movement of the doors 12, 12 but prevents the leaning passenger from falling out of the vehicle right away.

Upon the door control section 57 setting the speed for opening the doors 12, 12 to the cautionary speed, the door control section 57 transmits an alarm issuance instruction to the alarm 48. The alarm 48 issues an alarm in the vehicle cabin 14 in advance to opening of the doors 12, 12. The alarm may be a voice announcement or a warning message displayed on a display section such as a display in the vehicle cabin.

Reference to FIG. 5, whether or not there is luggage leaning against the door 12, 12 in the vicinity of the doors 12, 12 is determined by the luggage recognition section 55 and the luggage leaning determination section 56. The luggage recognition section 55 recognizes, from an image of the door vicinity area 28, the image being extracted by the image extraction section 51 (see FIG. 3), whether or not the image includes a luggage image area. The luggage recognition section 55 includes, for example, a convolutional neural network (CNN).

The convolutional neural network of the luggage recognition section 55 is trained in advance using training data with luggage images as input data and a class name of luggage as output data (ground truth data). The training data is stored in the trained model storage section 58. The luggage recognition section 55 recognizes whether or not a luggage image area is included from each of all of images of the door vicinity area 28 (door vicinity images) picked up by the imagers 24A to 24E.

Also, three-dimensional coordinates of the recognized luggage in the vehicle cabin 14 are obtained by the luggage recognition section 55. As with the face recognition section 52, the three-dimensional coordinates can be obtained by, for example, a stereo camera system using two of the imagers 24A to 24E. For example, the luggage recognition section 55 selects an arbitrary combination of two of the imagers 24A to 24E and obtains the three-dimensional coordinates of the recognized luggage image area from the respective images picked up by the two pickup devices. The luggage recognition section 55 transmits data of the luggage image area and the three-dimensional coordinates of the luggage image area to the luggage leaning determination section 56.

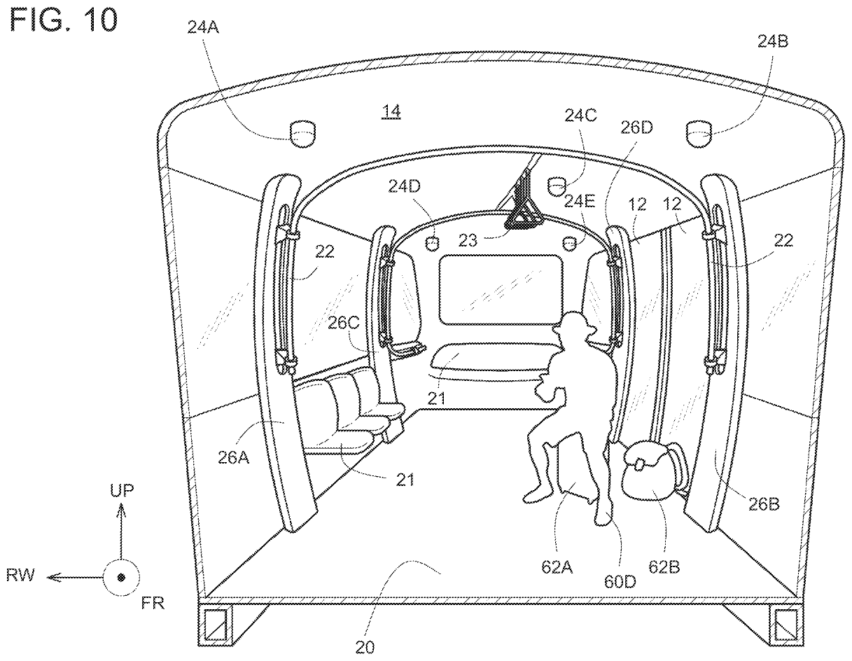

Also, no direction of luggage is taken into consideration in determination of whether or not the luggage is leaning. For example, FIG. 10 illustrates the inside of the vehicle cabin 14 in which a passenger 60D is seated on luggage 62A instead of a seat and luggage 62B is placed in such a manner as to lean against the door 12, 12.

The luggage 62B is leaning against the door 12, 12, and unless the passenger 60D moves the luggage 62B away from the doors 12, 12, the luggage 62B may fall out of the vehicle when the doors 12, 12 are opened. Therefore, as described later, the passenger 60D is urged to move the luggage 62B by issuance of an alarm and opening of the doors 12, 12 at the cautionary speed.

Referring to FIG. 5, the luggage leaning determination section 56 determines that the luggage placed in the vicinity of the doors 12, 12 is leaning against the door 12, 12, irrespective of the direction of the luggage. In other words, the luggage leaning determination section 56 determines whether or not the luggage recognized by the luggage recognition section 55 is leaning against the door 12, 12, based on a distance between the luggage and the doors 12, 12.

For example, the luggage leaning determination section 56 determines whether or not there is a luggage image area, a distance between a representative point of the luggage image area and a representative point of the doors 12, 12 being within a predetermined range (for example, 50 cm). The representative point of the luggage image area may be, for example, a highest point of the luggage image area. Also, the representative point of the doors 12, 12 may be, for example, a center point in the vehicle front-rear direction and the vehicle height direction of one of the doors 12, 12. A result of the luggage leaning determination is transmitted to the door control section 57.

Passenger Leaning Determination Flow

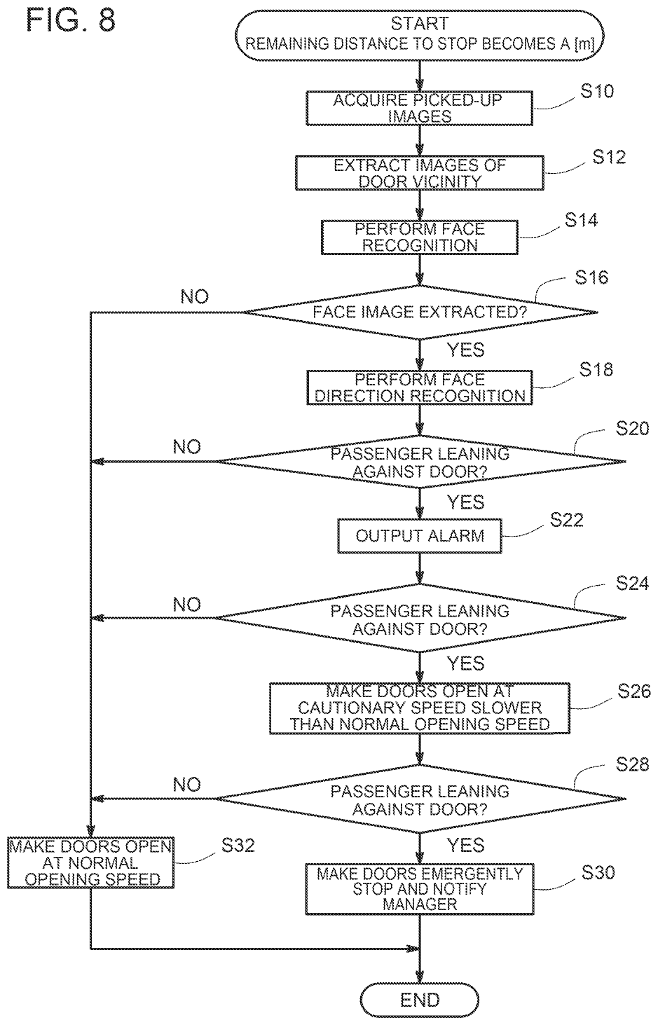

FIG. 8 illustrates an example of a passenger leaning determination flow in the leaning-against-vehicle door detection system 40 according to the present embodiment. When a remaining distance from a running vehicle 10 to a stop becomes a predetermined distance of A m (for example, 10 m), the image extraction section 51 acquires images picked up by the imagers 24A to 24E (S10). Furthermore, the image extraction section 51 extracts image areas each including the door vicinity area 28 (see FIG. 3) (door vicinity images) from the acquired picked-up images (S12).

The extracted door vicinity images are transmitted to the face recognition section 52. The face recognition section 52 performs face recognition in each of the door vicinity images using a convolutional neural network such as described above (S14). If no face image of a passenger is recognized in the door vicinity images (S16), such recognition processing result is transmitted to the passenger leaning determination section 54. The passenger leaning determination section 54 transmits a determination result that there is no passenger leaning to the door control section 57. In response to the determination result, the door control section 57 sets the normal opening speed as the speed for opening the doors 12, 12 (S32).

On the other hand, in step S16, if a face image of a passenger is recognized, the face recognition section 52 transmits data of the door vicinity image including the data indicating the recognized face image area to the head pose estimation section 53. The head pose estimation section 53 estimates a head pose, that is, a direction and an angle of the face, from a positional relationship between feature points of the face image area such as those described above (e.g., the eyes, the nose and the mouth) (S18).

Furthermore, the door vicinity image data including information of the head pose of the face in addition to the data indicating the face image area is transmitted to the passenger leaning determination section 54. The passenger leaning determination section 54 obtains a line-of-sight angle θ such as described above, and based on the line-of-sight angle θ, determines whether or not the passenger is leaning against the door 12, 12 (S20). The above leaning determination is performed for all of face image areas in each of all images with the face image area recognized from among the images picked up by the imagers 24A to 24E.

If it is determined by the passenger leaning determination section 54 that there is no passenger leaning against the door 12, 12, for each of the face image areas, the determination result that there is no passenger leaning is transmitted to the door control section 57. The door control section 57 sets the normal opening speed as the speed for opening the doors 12, 12 (S32).

On the other hand, if it is determined that there is a passenger leaning against the door 12, 12, for any of the face image areas, the passenger leaning determination section 54 transmits the determination result that there is a passenger leaning to the door control section 57. In response to the determination result, the door control section 57 transmits an alarm issuance instruction to the alarm 48. In response to the alarm issuance instruction, the alarm 48 outputs (issues) an alarm (a sound alarm or an alarm message) inside the vehicle cabin 14 before opening of the doors 12, 12 (S22).

After issuance of the alarm, the imagers 24A to 24E each pick up an image of the inside of the vehicle cabin 14. Based on the picked-up images, leaning determination is performed by the image extraction section 51, the face recognition section 52, the head pose estimation section 53 and the passenger leaning determination section 54 (S24). If a result of the determination is that there is no passenger leaning, the determination result is transmitted to the door control section 57. The door control section 57 sets the normal opening speed as the speed for opening the doors 12, 12 (S32).

On the other hand, in step S24, if it is determined by the passenger leaning determination section 54 that there is still a passenger leaning against the door, the determination result is transmitted to the door control section 57. The door control section 57 sets the cautionary speed as the speed for opening the doors 12, 12 (S26).

The door opening-closing motor is controlled by the door control section 57 to open the doors 12, 12 at the cautionary speed. During the opening, the imagers 24A to 24E each pick up an image of the inside of the vehicle cabin 14. Based on the picked-up images, leaning determination is performed by the image extraction section 51, the face recognition section 52, the head pose estimation section 53 and the passenger leaning determination section 54 (S28). If a result of the determination is that there is no passenger leaning, that is, the passenger leaning has been discontinued, the determination result is transmitted to the door control section 57. The door control section 57 sets the normal opening speed as the speed for opening the doors 12, 12 (S32).

On the other hand, in step S28 if it is determined by the passenger leaning determination section 54 that there is still a passenger leaning against the door, the determination result is transmitted to the door control section 57. The door control section 57 makes the doors 12, 12 emergently stop and transmits a message to the effect that opening of the doors 12, 12 is interrupted because of passenger leaning to an operation manager of the vehicle 10 (S30).

According to the above-described embodiment, when a passenger leaning against the door 12, 12 is detected, the leaning is discontinued by the issuance of an alarm before opening of the doors 12, 12. Furthermore, if the leaning is not discontinued by the issuance of the alarm, the passenger is actively urged from moving away from the doors 12, 12 by the doors 12, 12 being opened at the cautionary speed. Furthermore, if the leaning is not discontinued by these measures, opening of the doors 12, 12 is interrupted for passenger protection.

Another Example of Passenger Leaning Determination Flow

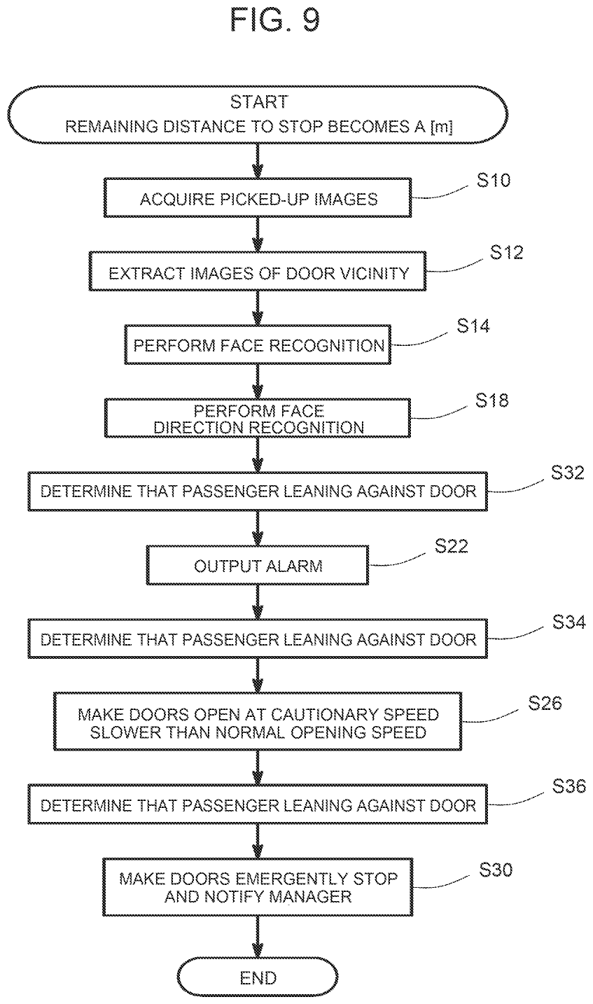

FIG. 9 illustrates another example of a passenger leaning determination flow in the leaning-against-vehicle door detection system according to the present embodiment. In the flow in FIG. 9, in brief, the conditional branches are omitted in comparison with the flow in FIG. 8. For example, this flow is executed when operation in the passenger leaning determination flow is checked. Also, for example, a maintenance staff member acting as a passenger intentionally leaning against the door 12, 12 rides in the vehicle cabin 14, and an image of the inside of the vehicle cabin 14 at that time is picked up by each of the imagers 24A to 24E.

In FIG. 9, determination of whether or not there is a face image recognized (S16) is omitted. Also, instead of steps S20, S24 and S28 to determine whether or not there is a passenger leaning, steps S32, S34, S36 to determine that there is a passenger leaning against the door 12, 12 are provided.

Luggage Leaning Determination Flow

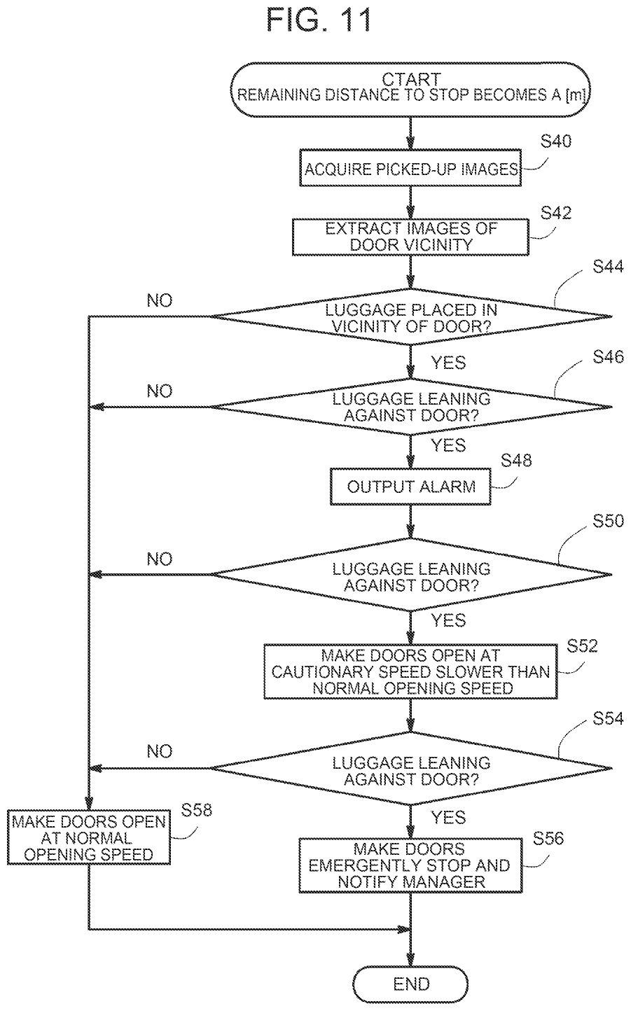

FIG. 11 illustrates an example of a luggage leaning determination flow in the leaning-against-vehicle door detection system 40 according to the present embodiment. This flow is executed in parallel with the passenger leaning determination flow in FIG. 8.

When a remaining distance from a running vehicle 10 to a stop becomes a predetermined distance of A m (for example, 10 m), the image extraction section 51 acquires images picked up by the imagers 24A to 24E (S40). Furthermore, the image extraction section 51 extracts image areas each including the door vicinity area 28 (see FIG. 3) (door vicinity images) from the acquired picked-up images (S42).

The extracted door vicinity images are transmitted to the luggage recognition section 55. The luggage recognition section 55 performs luggage recognition in each of the door vicinity images using a convolutional neural network such as described above (S44). If no luggage image is recognized in the door vicinity image, such recognition processing result is transmitted to the luggage leaning determination section 56. The luggage leaning determination section 56 transmits a determination result that there is no luggage leaning to the door control section 57. In response to the determination result, the door control section 57 sets the normal opening speed as the speed for opening the doors 12, 12 (S58).

On the other hand, in step S44, if a luggage image is recognized, the luggage recognition section 55 transmits data of the door vicinity image including the data indicating the recognized luggage image area to the luggage leaning determination section 56. The luggage leaning determination section 56 determines whether or not the recognized luggage is leaning against (in contact with) the door 12, 12 (S46).

For example, the luggage leaning determination section 56 determines whether or not there is a luggage image area, a distance between a representative point of the luggage image area and a representative point of the doors 12, 12 falling within a predetermined distance. This leaning determination is performed for all of luggage image areas in each of all of images with the luggage image area recognized from among the images picked up by the imagers 24A to 24E.

If it is determined by the luggage leaning determination section 56 that there is no luggage leaning against the door 12, 12, for each of the luggage image areas, the determination result that there is no luggage leaning is transmitted to the door control section 57. The door control section 57 sets the normal opening speed as the speed for opening the doors 12, 12 (S58).

On the other hand, if it is determined that there is luggage leaning against the door 12, 12, for any of the luggage image areas, the luggage leaning determination section 56 transmits the determination result that there is luggage leaning to the door control section 57. In response to the determination result, the door control section 57 transmits an alarm issuance instruction to the alarm 48. In response to the alarm issuance instruction, the alarm 48 outputs (issues) an alarm (a sound alarm or an alarm message) to the vehicle cabin 14 before opening of the doors 12, 12 (S48).

After issuance of the alarm, the imagers 24A to 24E each pick up an image of the inside of the vehicle cabin 14. Based on the picked-up images, leaning determination is performed by the image extraction section 51, the luggage recognition section 55 and the luggage leaning determination section 56 (S50). If a result of the determination is that there is no luggage leaning, the determination result is transmitted to the door control section 57. The door control section 57 sets the normal opening speed as the speed for opening the doors 12, 12 (S58).

On the other hand, in step S50, if it is determined by the luggage leaning determination section 56 that there is still luggage leaning against the door, the determination result is transmitted to the door control section 57. The door control section 57 sets the cautionary speed as the speed for opening the doors 12, 12 (S52).

The door opening-closing motor 49 is controlled by the door control section 57 to open the doors 12, 12 at the cautionary speed. During the opening, the imagers 24A to 24E each pick up an image of the inside of the vehicle cabin 14. Based on the picked-up images, leaning determination is performed by the image extraction section 51, the luggage recognition section 55 and the luggage leaning determination section 56 (S54). If a result of the determination is that there is no luggage leaning, that is, the luggage leaning has been discontinued, the determination result is transmitted to the door control section 57. The door control section 57 sets the normal opening speed as the speed for opening the doors 12, 12 (S58).

On the other hand, in step S54, if it is determined by the luggage leaning determination section 56 that there is still a luggage leaning against the door, the determination result is transmitted to the door control section 57. The door control section 57 makes the doors 12, 12 emergently stop and transmits a message to the effect that opening of the doors 12, 12 is interrupted because of luggage leaning to an operation manager of the vehicle 10 (S56).

According to the above-described embodiment, when luggage leaning against the door 12, 12 is detected, the leaning is discontinued by the issuance of an alarm before opening of the doors 12, 12. Furthermore, if the leaning is not discontinued by the issuance of the alarm, movement of the luggage away from the doors 12, 12 is actively urged by the doors 12, 12 being opened at the cautionary speed. Furthermore, if the leaning is not discontinued by these measures, opening of the doors 12, 12 is interrupted for luggage protection.

Note that the passenger leaning determination flow illustrated in FIG. 8 and the luggage leaning determination flow illustrated in FIG. 11 may be different in speed set in the door control section 57. For example, there may be a case where the cautionary speed is set in one of the flows and the normal opening speed is set in the other of the flows. If the set speeds conflict with each other in this way, the processing in the door control section 57 is prescribed in such a manner that the cautionary speed is preferentially selected.

Also, in a case where the passenger leaning determination flow in FIG. 8 and the luggage leaning determination flow illustrated in FIG. 11 are executed in parallel, one of the flows may be delayed relative to the other, resulting in occurrence of a time lag in set speed output. In this case, for example, the door control section 57 may set the speed for opening the doors 12, 12 after outputs in both step S24 in FIG. 8 and step S50 in FIG. 11.

Another Example of Luggage Leaning Determination Flow

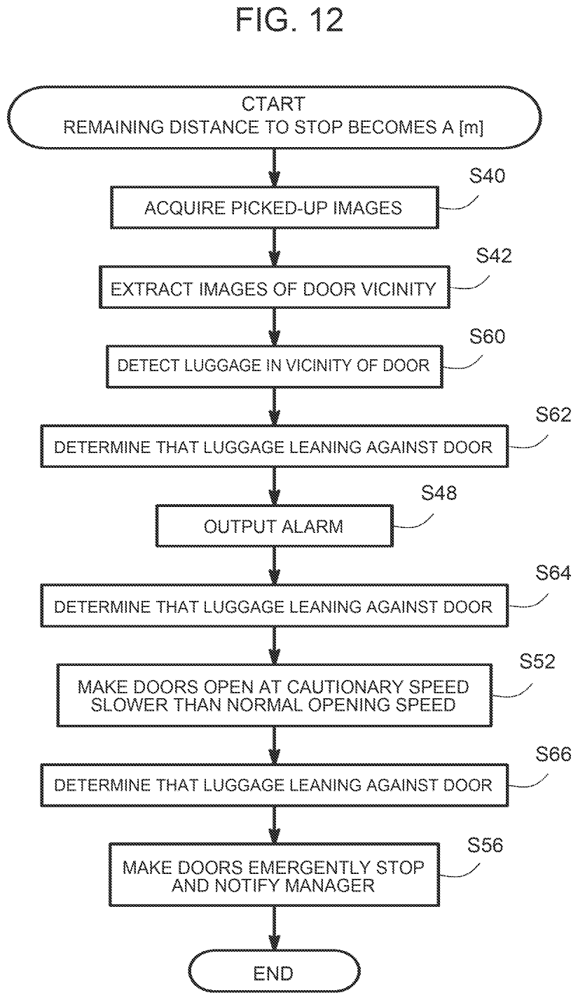

FIG. 12 illustrates another example of a luggage leaning determination flow in the leaning-against-vehicle door detection system according to the present embodiment. In this example, in brief, the conditional branches are omitted in comparison with the flow in FIG. 11. For example, this flow is executed when operation in the luggage leaning determination flow is checked. Also, luggage is intentionally placed in such a manner as to lean against the door 12, 12 in the vehicle cabin 14 and an image of the inside of the vehicle cabin 14 at that time is picked up by each of the imagers 24A to 24E.

Also, in FIG. 12, instead of determination of whether or not a luggage image is recognized (S44) and steps S46, S50 and S54 to determine whether or not there is luggage leaning, steps S60, S62, S64 and S66 to determine that there is luggage leaning against the door 12, 12 are provided.

In the above-described embodiment, when it is determined that there is at least either a passenger or luggage leaning, first, an alarm is issued from the alarm 48 and if the leaning is not discontinued by such alarm, the doors 12, 12 are opened at the cautionary speed; however, the leaning-against-vehicle door detection system 40 according to the present embodiment is not limited to this mode. For example, alarm issuance may be omitted and opening of the doors 12, 12 at the cautionary speed may be performed alone. Also, the doors 12, 12 may be opened at the cautionary speed simultaneously with issuance of an alarm.

What is claimed is:

1. A leaning-against-vehicle door detection system comprising:
an imager having an image pickup range including a door of a vehicle and a vicinity of the door inside a vehicle cabin; and
a determination device that determines whether or not there is a passenger or luggage leaning against the door, from an image picked up by the imager.

2. The leaning-against-vehicle door detection system according to claim 1, wherein the determination device includes:
a face recognition section that recognizes a face of a passenger in the vicinity of the door from the picked-up image;
a head pose estimation section that estimates a direction of the recognized face; and
a passenger leaning determination section that determines whether or not the passenger is leaning against the door, based on the estimated direction of the face.

3. The leaning-against-vehicle door detection system according to claim 1, wherein the determination device includes:
a luggage recognition section that recognizes luggage in the vicinity of the door, from the picked-up image; and
a luggage leaning determination section that determines whether or not the recognized luggage is leaning against the door, based on a distance between the luggage and the door.

4. The leaning-against-vehicle door detection system according to claim 1, comprising an alarm that when it is determined by the determination device that there is a passenger or luggage leaning against the door, issues an alarm before opening of the door.

5. The leaning-against-vehicle door detection system according to claim 1, comprising a door control section that when it is determined by the determination device that there is a passenger or luggage leaning against the door, makes the door open at a cautionary speed that is slower than a predetermined normal opening speed.

6. The leaning-against-vehicle door detection system according to claim 5, wherein when it is determined by the determination device that the passenger or the luggage leaning against the door is discontinued, the door control section makes the door open at the normal opening speed.
